(19) United States
(12) Patent Application Publication
(10) Pub. No.: US 2025/0107518 A1
(43) Pub. Date: Apr. 3, 2025

(54) Rodent Bait Delivery Device

(71) Applicant: William Luthi, Silverton, OR (US)

(72) Inventor: William Luthi, Silverton, OR (US)

(21) Appl. No.: 18/376,292

(22) Filed: Oct. 3, 2023

(51) Int. Cl. A01M 25/00

(52) U.S. Cl. CPC A01M 25/006

(57) ABSTRACT

A rodent bait delivery device for delivering bait into a rodent hole includes a first tube, a second tube, and a hopper. The second tube is complementary to and slidably positioned in the first tube. The hopper is engaged to the first tube so that a bottom of the hopper is positioned proximate to a lower end of the first tube. An opening positioned in a top of the hopper allows for addition of a flowable bait. A first aperture is positioned in the first tube proximate to the bottom of the hopper. A second aperture is positioned in the second tube so that the second aperture is selectively alignable with the first aperture to fluidically engage the second tube to the hopper, thus allowing the flowable bait to flow from the hopper and through the second tube into a rodent hole.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to delivery devices and more particularly pertains to a new delivery device for delivering bait into a rodent hole. The present invention discloses a delivery device comprising a first tube having a second tube slidably positioned within it. A hopper engaged to the first tube allows a flowable bait to pass from the hopper through the second tube and into a rodent hole upon selective alignment of holes positioned in the first and second tubes

### (2) Description of Related Art Including Information Disclosed Under 37 CFR 1.97 and 1.98

The prior art relates to delivery devices, and more particularly to delivery devices for delivering bait into a rodent hole. Prior art delivery devices may comprise tubes with selectively rotatable flaps allowing bait to flow through the tubes, dispensers mounted to ground penetrating tubes, and syringe like devices for delivering liquids. What is lacking in the prior art is a delivery device comprising a first tube having a second tube slidably positioned within it. A hopper engaged to the first tube allows a flowable bait to pass from the hopper through the second tube and into a rodent hole upon selective alignment of holes positioned in the first and second tubes.

### BRIEF SUMMARY OF THE INVENTION

An embodiment of the disclosure meets the needs presented above by generally comprising a first tube, a second tube, and a hopper. The second tube is circumferentially complementary to, and slidably positioned in, the first tube so that the second tube is selectively extendable from a lower end of the first tube. The hopper is engaged to the first tube so that a bottom of the hopper is positioned proximate to the lower end of the first tube. An opening positioned in a top of the hopper is configured for addition of a flowable bait to the hopper. A first aperture is positioned in the first tube proximate to the bottom of the hopper so that the first tube is in fluidic communication with the hopper. A second aperture is positioned in the second tube so that the second aperture is selectively alignable with the first aperture to fluidically engage the second tube to the hopper, thus allowing the flowable bait to flow from the hopper to the second tube. The second tube is configured to direct the flowable bait into a rodent hole.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a rodent bait delivery device according to an embodiment of the disclosure.

FIG. 2 is an in-use view of an embodiment of the disclosure.

FIG. 3 is an in-use view of an embodiment of the disclosure.

FIG. 4 is a rear view of an embodiment of the disclosure.

FIG. 5 is a bottom view of an embodiment of the disclosure.

FIG. 6 is a top view of an embodiment of the disclosure.

FIG. 7 is a cross-sectional view of an embodiment of the disclosure.

### DETAILED DESCRIPTION OF THE INVENTION

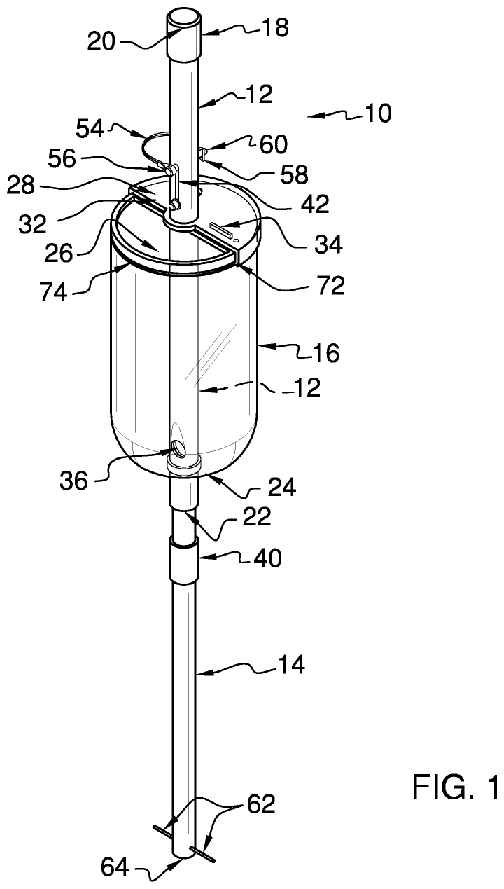

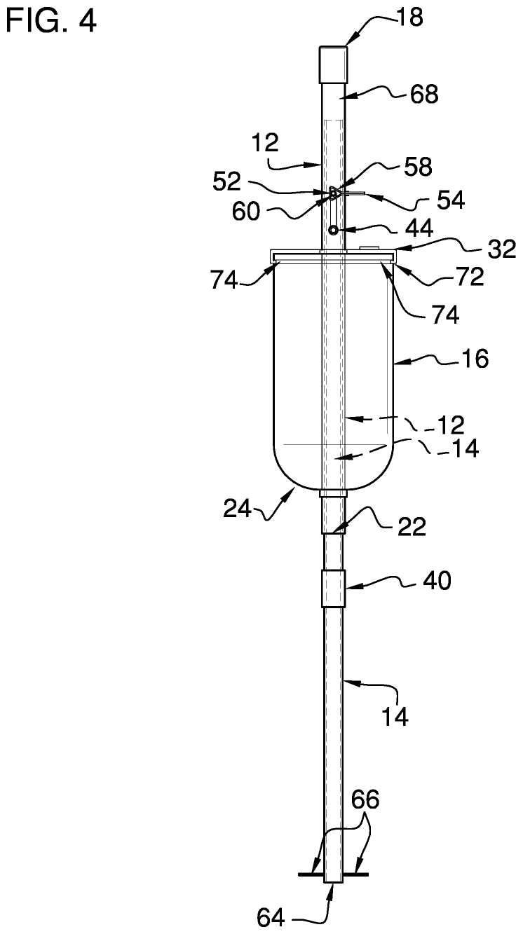

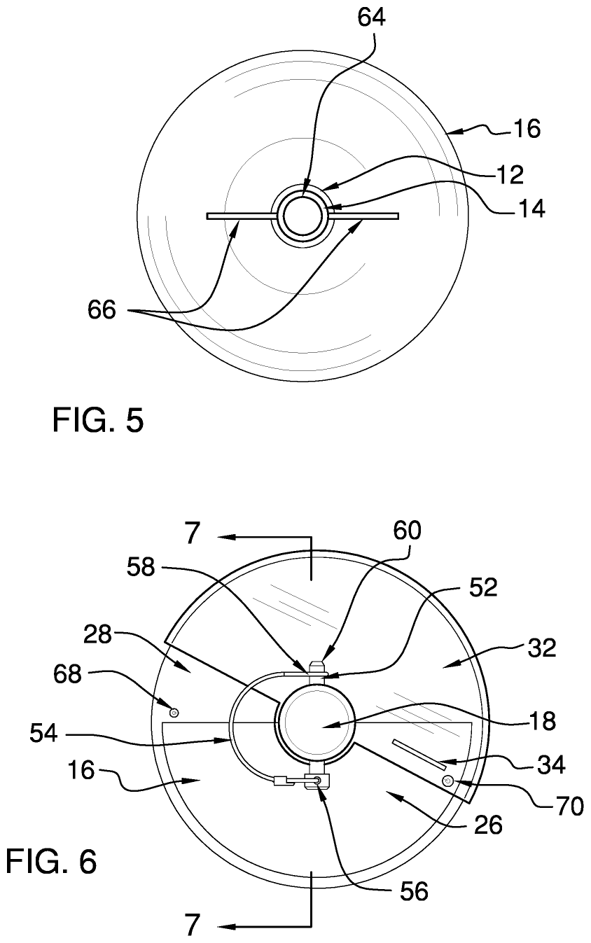

With reference now to the drawings, and in particular to FIGS. 1 through 7 thereof, a new delivery device embodying the principles and concepts of an embodiment of the disclosure and generally designated by the reference numeral 10 will be described.

As best illustrated in FIGS. 1 through 7, the rodent bait delivery device 10 generally comprises a first tube 12, a second tube 14, and a hopper 16. A cap 18 is engaged to an upper end 20 of the first tube 12. The second tube 14 is circumferentially complementary to, and slidably positioned in, the first tube 12 so that the second tube 14 is selectively extendable from a lower end 22 of the first tube 12.

The hopper 16 is engaged to the first tube 12 so that a bottom 24 of the hopper 16 is positioned proximate to the lower end 22 of the first tube 12. An opening 26 positioned in a top 28 of the hopper 16 is configured for addition of a flowable bait 30 to the hopper 16. The flowable bait 30 would comprise a poison appropriate for a targeted species of rodent. The hopper 16 may be substantially cylindrically shaped, as shown in FIG. 1, although the present invention anticipates the hopper 16 being alternatively shaped, such as, but not limited to, cuboid, spherical, and the like. The first tube 12 extends axially through the hopper 16. The bottom 24 of the hopper 16 is inverted dome shaped so that the flowable bait 30 is directed toward the first tube 12.

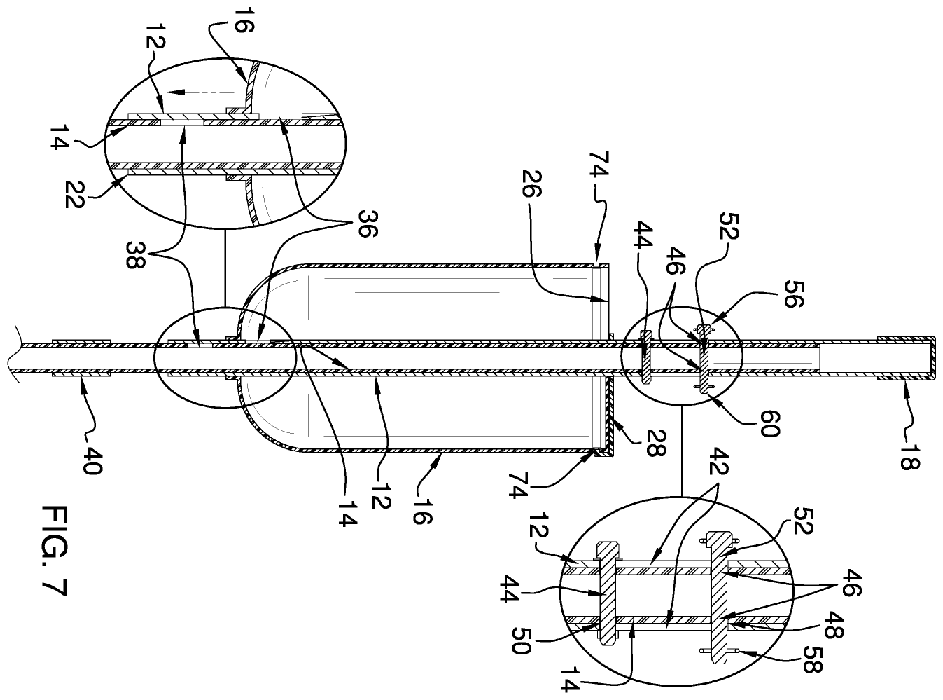

A lid 32 is engaged to the top 28 of the hopper 16 proximate to the opening 26 so that the lid 32 is positioned to selectively close the opening 26. The lid 32 is substantially semicircularly shaped and is rotationally engaged to the hopper 16 and to the first tube 12. The lid 32 can be rotated to close the opening 26. The present invention anticipates a tab 34 engaged to the lid 32. The tab 34 is configured to be engaged by a digit of a hand of a user to selectively rotate the lid 32 to open and to close the opening 26. As shown in FIG. 6, a dimple 68 is engaged to the top 28 and is positioned to selectively engage a recess 70, which is positioned in the lid 32, to retain the lid 32 over the opening 26. A lip 72 is engaged to and extends from the lid 32. The lip is positioned in a channel 74 that extends circumferentially around the hopper 16 proximate to the top 28, thereby slidably engaging the lid 32 to the hopper 16.

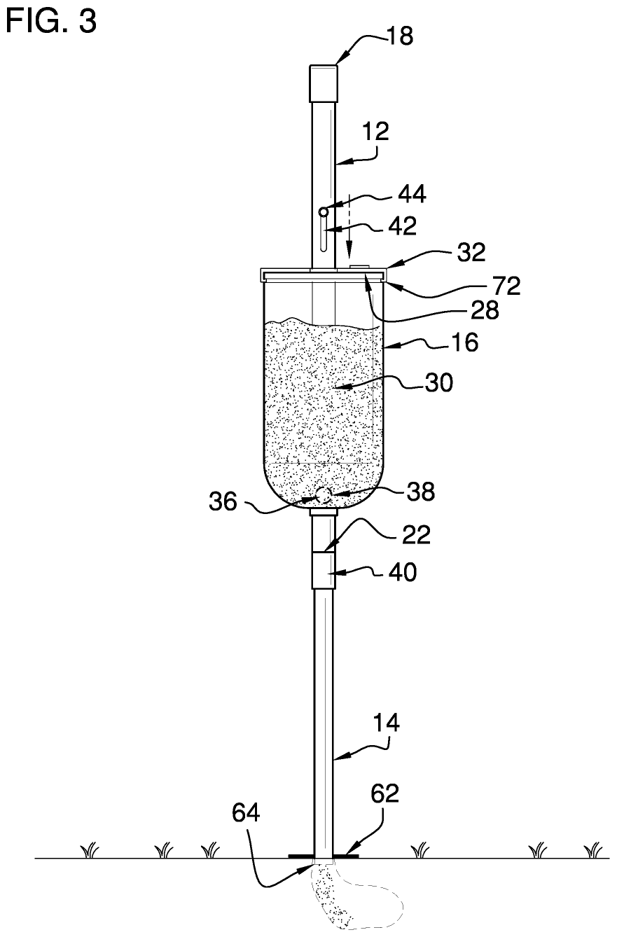

A first aperture 36 is positioned in the first tube 12 proximate to the bottom 24 of the hopper 16 so that the first tube 12 is in fluidic communication with the hopper 16. A second aperture 38 is positioned in the second tube 14 so that the second aperture 38 is selectively alignable with the first aperture 36 to fluidically engage the second tube 14 to the hopper 16, thus allowing the flowable bait 30 to flow from the hopper 16 to the second tube 14. The second tube 14 is configured to direct the flowable bait 30 into a rodent hole, as shown in FIG. 3.

The present invention is anticipated to be useful in delivering flowable bait 30 to a plurality of rodent holes. A user can deliver flowable bait 30 to the rodent holes without bending, stooping, or kneeling, thus reducing strain on a back of the user and allowing for delivery of flowable bait 30 to a large number of rodent holes in a shortened time.

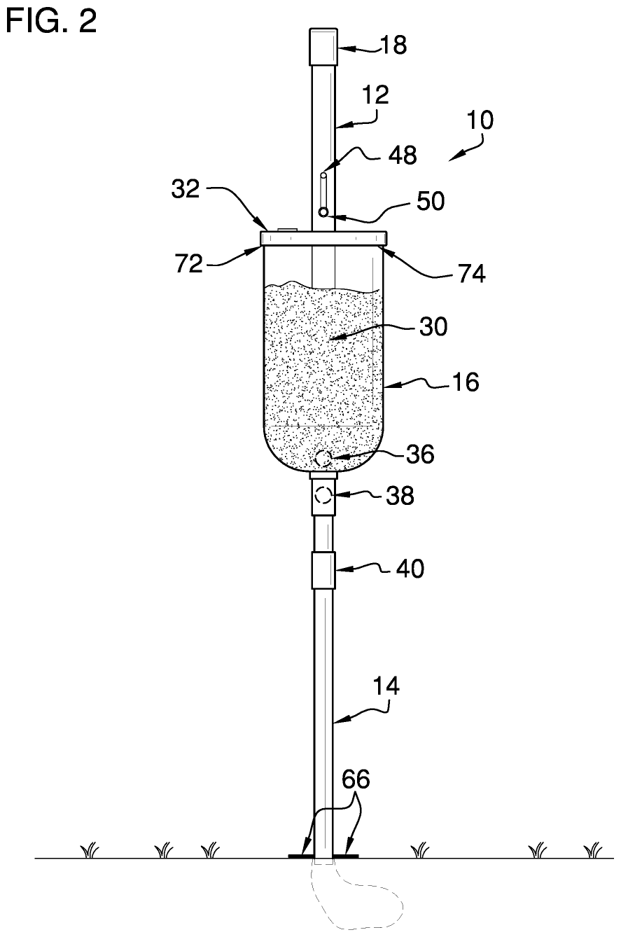

A pipe 40 is positioned around and is fixedly engaged to the second tube 14 proximate to the lower end 22 of the first tube 12, as shown in FIG. 2. The pipe 40 contacts the lower end 22 of the first tube 12, as shown in FIG. 3, upon insertion of the second tube 14 into the first tube 12 to a point at which the second aperture 38 is aligned with the first aperture 36.

The slots 42 of a pair of slots 42 are opposingly positioned in the first tube 12, as shown in FIG. 7. The slots 42 extend longitudinally in the first tube 12 above the top 28 of the hopper 16. A bar 44 is engaged to the second tube 14 and extends through the pair of slots 42. The bar 44 is slidable within the pair of slots 42 as the second tube 14 is slid within the first tube 12. The bar 44 prevents rotation of the second tube 14 relative to the first tube 12 to maintain the second aperture 38 in a selectively alignable orientation with the first aperture 36.

A pair of pin holes 46 is positioned in the second tube 14, as shown in FIG. 7. The pin holes 46 are positioned proximate to an upper terminus 48 of the pair of slots 42 when the bar 44 is positioned at a lower terminus 50 of the pair of slots 42. A locking pin 52 is selectively insertable through the pair of slots 42 and the pair of pin holes 46. The second tube 14 thus is fixedly positioned relative to the first tube 12 with the second aperture 38 being unaligned with the first aperture 36, thereby preventing the flowable bait 30 from flowing from the hopper 16 to the second tube 14.

A cable 54 is engaged to a first end 56 of the locking pin 52. A ring 58 is engaged to the cable 54 distal from the locking pin 52 so that the ring 58 is positionable over a second end 60 of the locking pin 52 upon insertion of the locking pin 52 through the pair of slots 42 and the pair of pin holes 46. The ring 58 frictionally engages the locking pin 52 to prevent inadvertent extraction of the locking pin 52 from the pair of slots 42 and the pair of pin holes 46.

A protrusion 62 is engaged to and extends substantially perpendicularly from the second tube 14 proximate to a lower limit 64 of the second tube 14. The protrusion 62 is configured to contact a surface proximate to the rodent hole to limit entry of the second tube 14 into the rodent hole, as shown in FIG. 3. Upon lifting of the protrusion 62 from the surface, the second tube 14 is extended from the first tube 12 and the second aperture 38 is unaligned with the first aperture 36. The protrusion 62 may comprise a pair of rods 66, the rods 66 of which are opposingly positioned on the second tube 14. The present invention anticipates the protrusion 62 comprising other protruding elements, such as, but not limited to, discs, rings, and the like.

In use, a flowable bait 30 is positioned in the hopper 16 and the lid 32 is closed. A user grasps the first tube 12 above the hopper 16 and maneuvers the lower limit 64 of the second tube 14 into a rodent hole. The user then pushes down on the first tube 12 so the pair of rods 66 engages the surface proximate to the rodent hole, thus pushing the second tube 14 into the first tube 12. When the second aperture 38 aligns with the first aperture 36, the flowable bait 30 flows from the hopper 16 through the second tube 14 and into the rodent hole. When the user lifts the rods 66 off the surface, the second aperture 38 loses its alignment with the first aperture 36 the flow of flowable bait 30 ceases.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A rodent bait delivery device comprising:
a first tube;
a hopper engaged to the first tube, such that a bottom of the hopper is positioned proximate to a lower end of the first tube;
an opening positioned in a top of the hopper, wherein the opening is configured for addition of a flowable bait to the hopper;
a second tube, the second tube being circumferentially complementary to, and slidably positioned in, the first tube, such that the second tube is selectively extendable from the lower end of the first tube;
a first aperture positioned in the first tube proximate to the bottom of the hopper, such that the first tube is in fluidic communication with the hopper; and
a second aperture positioned in the second tube, such that the second aperture is selectively alignable with the first aperture for fluidically engaging the second tube to the hopper, such that the flowable bait flows from the hopper to the second tube, wherein the second tube is configured for directing the flowable bait into a rodent hole.

2. The rodent bait delivery device of claim 1, further including a cap engaged to an upper end of the first tube.

3. The rodent bait delivery device of claim 1, wherein:
the hopper is substantially cylindrically shaped; and
the first tube extends axially through the hopper.

4. The rodent bait delivery device of claim 3, wherein the bottom of the hopper is inverted dome shaped.

5. The rodent bait delivery device of claim 3, further including a lid engaged to the top of the hopper proximate to the opening, such that the lid is positioned for selectively closing the opening.

6. The rodent bait delivery device of claim 5, wherein:
the lid is substantially semicircularly shaped; and
the lid is rotationally engaged to the hopper and to the first tube, such that the lid is rotatable for closing the opening.

7. The rodent bait delivery device of claim 6, further including:
a channel extending circumferentially around the hopper proximate to the top;
a lip engaged to and extending from the lid, the lip being positioned in the channel, such that the lid is slidably engaged to the hopper;
a tab engaged to the lid, wherein the tab is configured for engaging a digit of a hand of a user for selectively rotating the lid for opening and for closing the opening;
a recess positioned in the lid; and
a dimple engaged to the top and positioned to selectively engage the recess to retain the lid over the opening.

8. The rodent bait delivery device of claim 1, further including a pipe positioned around and fixedly engaged to the second tube proximate to the lower end of the first tube, such that the pipe contacts the lower end of the first tube upon insertion of the second tube into the first tube to a point at which the second aperture is aligned with the first aperture.

9. The rodent bait delivery device of claim 1, further including:
a pair of slots opposingly positioned in the first tube, the slots extending longitudinally in the first tube above the top of the hopper; and
a bar engaged to the second tube and extending through the pair of slots, such that the bar is slidable within the pair of slots as the second tube is slid within the first tube, such that the bar prevents rotation of the second tube relative to the first tube for maintaining the second aperture in a selectively alignable orientation with the first aperture.

10. The rodent bait delivery device of claim 9, further including:
a pair of pin holes positioned in the second tube, such that the pin holes are positioned proximate to an upper terminus of the pair of slots when the bar is positioned at a lower terminus of the pair of slots; and
a locking pin selectively insertable through the pair of slots and the pair of pin holes, such that the second tube is fixedly positioned relative to the first tube with the second aperture being unaligned with the first aperture, thereby preventing the flowable bait from flowing from the hopper to the second tube.

11. The rodent bait delivery device of claim 10, further including:
a cable engaged to a first end of the locking pin; and
a ring engaged to the cable distal from the locking pin, such that the ring is positionable over a second end of the locking pin upon insertion of the locking pin through the pair of slots and the pair of pin holes, such that the ring frictionally engages the locking pin for preventing inadvertent extraction of the locking pin from the pair of slots and the pair of pin holes.

12. The rodent bait delivery device of claim 1, further including a protrusion engaged to and extending substantially perpendicularly from the second tube proximate to a lower limit of the second tube, wherein the protrusion is configured for contacting a surface proximate to the rodent hole for limiting entry of the second tube into the rodent hole.

13. The rodent bait delivery device of claim 12, wherein the protrusion comprises a pair of rods, the rods being opposingly positioned on the second tube.

14. A rodent bait delivery system comprising:
a first tube;
a hopper engaged to the first tube, such that a bottom of the hopper is positioned proximate to a lower end of the first tube;
an opening positioned in a top of the hopper;
a flowable bait positioned in the hopper;
a second tube, the second tube being circumferentially complementary to, and slidably positioned in, the first tube, such that the second tube is selectively extendable from the lower end of the first tube;
a first aperture positioned in the first tube proximate to the bottom of the hopper, such that the first tube is in fluidic communication with the hopper; and
a second aperture positioned in the second tube, such that the second aperture is selectively alignable with the first aperture for fluidically engaging the second tube to the hopper, such that the flowable bait flows from the hopper through the second tube and into a rodent hole.

15. A rodent bait delivery device comprising:
a first tube;
a cap engaged to an upper end of the first tube;
a hopper engaged to the first tube, such that a bottom of the hopper is positioned proximate to a lower end of the first tube, the hopper being substantially cylindrically shaped, the first tube extending axially through the hopper, the bottom of the hopper being inverted dome shaped;
an opening positioned in a top of the hopper, wherein the opening is configured for addition of a flowable bait to the hopper;
a lid engaged to the top of the hopper proximate to the opening, such that the lid is positioned for selectively closing the opening the lid being substantially semicircularly shaped, the lid being rotationally engaged to the hopper and to the first tube, such that the lid is rotatable for closing the opening;
a channel extending circumferentially around the hopper proximate to the top;
a lip engaged to and extending from the lid, the lip being positioned in the channel, such that the lid is slidably engaged to the hopper;
a tab engaged to the lid, wherein the tab is configured for engaging a digit of a hand of a user for selectively rotating the lid for opening and for closing the opening;
a recess positioned in the lid;
a dimple engaged to the top and positioned to selectively engage the recess to retain the lid over the opening;
a second tube, the second tube being circumferentially complementary to, and slidably positioned in, the first tube, such that the second tube is selectively extendable from the lower end of the first tube;
a first aperture positioned in the first tube proximate to the bottom of the hopper, such that the first tube is in fluidic communication with the hopper;
a second aperture positioned in the second tube, such that the second aperture is selectively alignable with the first aperture for fluidically engaging the second tube to the hopper, such that the flowable bait flows from the hopper to the second tube, wherein the second tube is configured for directing the flowable bait into a rodent hole;
a pipe positioned around and fixedly engaged to the second tube proximate to the lower end of the first tube, such that the pipe contacts the lower end of the first tube upon insertion of the second tube into the first tube to a point at which the second aperture is aligned with the first aperture;
a pair of slots opposingly positioned in the first tube, the slots extending longitudinally in the first tube above the top of the hopper;
a bar engaged to the second tube and extending through the pair of slots, such that the bar is slidable within the pair of slots as the second tube is slid within the first tube, such that the bar prevents rotation of the second tube relative to the first tube for maintaining the second aperture in a selectively alignable orientation with the first aperture;
a pair of pin holes positioned in the second tube, such that the pin holes are positioned proximate to an upper terminus of the pair of slots when the bar is positioned at a lower terminus of the pair of slots;
a locking pin selectively insertable through the pair of slots and the pair of pin holes, such that the second tube is fixedly positioned relative to the first tube with the second aperture being unaligned with the first aperture, thereby preventing the flowable bait from flowing from the hopper to the second tube;
a cable engaged to a first end of the locking pin;
a ring engaged to the cable distal from the locking pin, such that the ring is positionable over a second end of the locking pin upon insertion of the locking pin through the pair of slots and the pair of pin holes, such that the ring frictionally engages the locking pin for preventing inadvertent extraction of the locking pin from the pair of slots and the pair of pin holes; and
a protrusion engaged to and extending substantially perpendicularly from the second tube proximate to a lower limit of the second tube, wherein the protrusion is configured for contacting a surface proximate to the rodent hole for limiting entry of the second tube into the rodent hole, the protrusion comprising a pair of rods, the rods being opposingly positioned on the second tube.
